(19) United States
(12) Patent Application Publication
(10) Pub. No.: US 2022/0059877 A1
(43) Pub. Date: Feb. 24, 2022

(54) ELECTRODE ASSEMBLY UNIT, MANUFACTURING METHOD AND BATTERY CELL

(71) Applicant: Do Fluoride Jiaozuo New Energy Tech Co Ltd, Jiaozuo (CN)

(72) Inventors: Pan Wang, Jiaozuo (CN); Hongtao Ma, Jiaozuo (CN); Fei Xu, Jiaozuo (CN); Yongfeng Zhao, Jiaozuo (CN); Xingfu Liu, Jiaozuo (CN); Hongjuan Zhao, Jiaozuo (CN); Huifang Zhao, Jiaozuo (CN); Yu Ma, Jiaozuo (CN); Jing Zhao, Jiaozuo (CN)

(73) Assignee: Do Fluoride Jiaozuo New Energy Tech Co Ltd, Jiaozuo (CN)

(21) Appl. No.: 17/413,165

(22) PCT Filed: Dec. 13, 2018
(86) PCT No.: PCT/IB2018/060054

§ 371 Date: Jun. 11, 2021

(51) Int. Cl. H01M 10/0585; H01M 50/46; H01M 50/466

(52) U.S. Cl. CPC H01M 10/0585; H01M 10/0525; H01M 50/466; H01M 50/46

(57) ABSTRACT

The embodiment claims an electrode assembly, its manufacturing method and battery cell made of such. The assembly unit from the top to bottom integrates first electrode plate, first separator plate, second electrode plate, second separator plate and another first electrode plate. The polarity of the first and second electrode plate is opposite to each other. The edges of the first and second separator plates join on one side forming U shape structure. The electrode assembly in this embodiment is a unit for multiple stacking of such to form the internal structure of a battery cell. Such design offers improved efficiency in cell manufacturing and achieves accurate alignments between positive and negative electrodes. The assembly unit upon numerous stacking would ensure overall alignments of positive and negative electrodes for cell quality improvement.

### TECHNICAL FIELD

This disclosure relates to the structure of a lithium-ion battery (LIB) and the manufacturing method of electrode assembly units and the battery cell of this structure.

### BACKGROUND

With the development of the modern society, the contradiction has been more severe between the gasoline/diesel vehicles and environmental pollution. Because of its high operating voltage, high energy density, safety excellence, lightweight, low self-discharge, long cycle life and little pollution, power LIB has been widely applied in new energy vehicles, such as Electrical vehicles (EV), Hybrid Electrical Vehicles (HEV), Parallel Hybrid Electrical Vehicles (PHEV).

The assembly process of the power battery is mainly the winding and the stacking. Because the market has special requirements (high power and high energy) for the power battery, the stacking is becoming the major assembly process in the industry. For example, patent CN203690428U, relates to a safety core stacking structure, comprising a positive electrode sheet, a negative electrode sheet and a separator. The separator is designed in a zigzag pattern with layer gaps for alternatively stacking positive electrode sheets and negative electrode sheets. When the positive and negative electrode sheets are inserted into the corresponding layer gaps respectively, the zigzag stacking structure will be formed.

During an assembly process, the procedures of the zigzag stacking are cyclic by four steps: placing the first electrode plate, stacking the separator, placing the second electrode plate and stacking the separator. Such assembly process has low efficiency and inaccurate alignments between positive and negative electrodes, which may cause unsafe operation in the battery.

### BRIEF DESCRIPTION OF THE DRAWINGS

In drawings which illustrate by way of example only a preferred embodiment of the disclosure,

FIG. 1 is a structural diagram of a battery cell.

FIG. 2 is a structural diagram of the first electrode assembly unit shown in FIG. 1.

FIG. 3 is a structural diagram of the second electrode assembly unit shown in FIG. 1

FIG. 4 is a structural diagram of the stacking block formed by stacking of the first electrode assembly unit and second electrode assembly unit.

FIG. 5 is a structural diagram of another stacking arrangement of the second electrode assembly unit.

FIG. 6 is a structural diagram of another stacking arrangement of the battery cell.

### DETAILED DESCRIPTION

The present embodiment is an electrode assembly unit directed to the problems of low efficiency and inaccurate alignments in the zig-zag stacking process. This disclosure also offers a manufacturing method of an electrode assembly unit and battery cell.

The technical scheme of the electrode assembly unit in this embodiment may include the following.

An electrode assembly unit may include a first electrode plate, a first separator plate, a second electrode plate, a second separator plate and another first electrode plate. The polarity of the first and second electrode plate are opposite to each other. The edges of the first and second separator plates may be joined on one side forming a U-shape structure.

An electrode assembly unit may comprise a top separator plate, an electrode plate and a bottom separate plate.

The main stacking block may be formed by stacking of electrode assembly units and a battery cell may be produced by stacking of main stacking blocks. This process can significantly improve the efficiency in cell manufacturing and avoid the negative influence on the cell quality from the stacking of the separator. Meanwhile, this also helps achieve accurate alignments between positive and negative electrodes and upon numerous stacking would assist with overall alignments of assembly units for cell quality improvement.

Both sides of the first separator plate and the second plate may have adhesive layers to attach electrode plates. Layers of ceramic particles (Al₂O₃ or Boehmite) placed between the surfaces of the separator plate and their adhesive layers may enhance the safety aspect of the separator.

A U-shaped structure may be formed by joining the corresponding end parts on one side of the top separator plate and the bottom separator plate.

Furthermore, the electrode assembly unit in this embodiment may resolve the problem of misalignments between electrodes. The first separator plate and the second separator plate are from a 180-degree folding of one separator plate in a U shape. On the one hand, this would reduce the numbers of die cutting and avoid the cutting accuracy error from the multiple die cutting, on the other hand, a certain amount of the electrolyte can be retained at the U-shaped bottom, which helps prolong the cycle life of the battery.

The manufacturing method of an electrode assembly unit may comprise a process of stacking the first electrode assembly unit with the second electrode assembly unit. As mentioned above, the first electrode assembly unit may consist of first electrode plate, first separator plate, second electrode plate, second separator plate and another first electrode plate. The polarity of the first and second electrode plate are opposite to each other. The edges of the first and second separator plates join on one side forming a U-shape structure. The second electrode assembly unit may comprise a top separator plate, an electrode plate and a bottom separate plate

Attachment of separator plate and adjacent electrode plate may be achieved by adhesion or electrostatic attraction.

The manufacturing method and fabrication process of the electrode assembly unit may be comparatively simple, may provide accurate alignment during the stacking of positive electrode plate and the negative electrode plate, hence delivering enhanced safety aspect of the cell.

A battery cell is may be formed by an electrode assembly unit or formed by stacking of more than two electrode assembly units. All the electrode assembly units may be produced using the method and process mentioned above.

Both sides of the first separator plate and the second plate may have adhesive layers to attach electrode plates. Layers of ceramic particles (Al₂O₃ or Boehmite) placed between the surfaces of the separator plate and their adhesive layers may enhance the safety aspect of the separator.

A U-shaped structure may be formed by joining the corresponding end parts on one side of the top separator plate and the bottom separator plate.

More than two electrode assembly units stacking together may form a main stacking block. A negative electrode plate may be connected to the outermost positive electrode plate on the main stacking block with a separator plate in-between.

The battery cell manufactured using the method may have a simple stacking structure, high assembly efficiency, and great alignment accuracy when stacking electrode plates. This method can effectively improve the quality of battery cell manufacturing.

The following is an explanation with reference to the drawings.

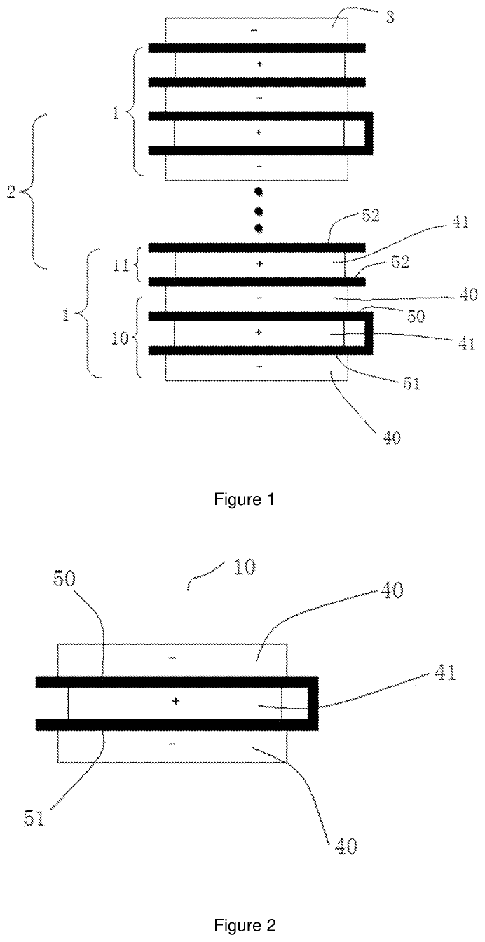

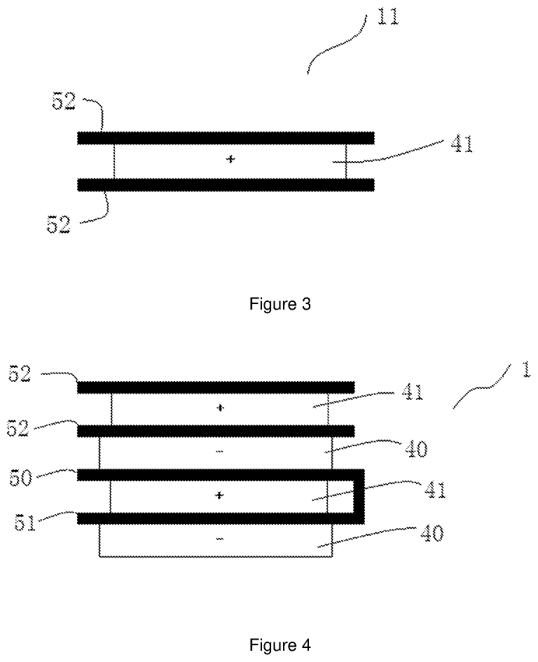

As shown in FIGS. 1 to 4, main stacking block 2 may be formed by stacking of multiple electrode assembly units 1 and an assisting electrode plate 3 that attaches to one end of the main stacking block 2. The electrode assembly unit 1 may be formed by stacking of second electrode assembly unit 11 on top of the first electrode assembly unit 10.

The first electrode assembly unit 10 may consist of joining of multiple electrode plate and separator plate in an order of one first electrode plate 40; one first separator plate 50; second electrode plate 41; second separator plate 51 and a first electrode plate 40 at the bottom. The first electrode plate contains negative charges, the second electrode plate contains positive charges and the assisting electrode plate 3 contains negative charges.

The first and second separator plate may be formed by a continuous separator plate that folds 180 degrees and formed a U-shaped structure that holds a second electrode plate. The second electrode assembly unit may comprise a U-shaped third separator plate 52 that is formed by a continuous separator plate that folds 180 degrees, with a second electrode plate 41 inside the U-shaped structure and bonded with both sides of the separator plate 52. The battery cell for farther assembly may be formed by stacking of the first electrode assembly unit with the second electrode assembly unit.

Away from the edges there may be a layer of ceramic particles and layer of adhesive on the two surfaces of the first, second and third separator plates. The layer of the ceramic particles may reduce the risk of electroactive material puncturing the separator for increased safety. The adhesion layer is for attaching the first and second electrode plates aligned in the same direction.

For the first electrode assembly unit not having the first and second separator plates arranged separately, eliminates a cutting process which may increase production efficiency and may reduce accuracy error during cutting. Also, the U shape structure may retain a certain amount of electrolyte which would help prolong the cycle life of battery cell.

The positive electrode plate is the supplier of Li⁺ and may determine the capacity of the cell. The addition of auxiliary electrode plate help ensures the positive electrode plate on the outmost side of the assembly unit is covered, this ensures the capacity of the positive electrode plate would be fully utilized resulting improved capacity and energy density of the cell.

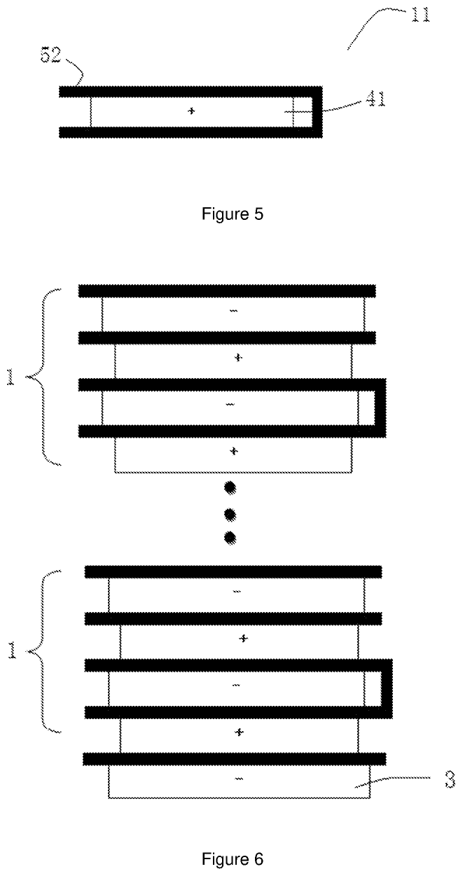

As in other arrangements of the cell in this embodiment, in the first electrode assembly unit, the first and second separator plates may be stacked separately. The second electrode assembly unit as in FIG. 5 has the separator plate folded in 180 degrees forming U shape structure around the second electrode plate. The polarity of the first and second electrode plates are interchangeable as shown in FIG. 6. The layer of adhesion on the surface of separator plate is not necessarily required as the attachment of separator to the adjacent electrode plate can also be achieved by applying electrostatic force.

The manufacturing method of the electrode assembly includes stacking of the first and second electrode assembly units forming a stacking block.

The implementation of the electrode assembly unit may have a similar structure as electrode assembly unit of the battery cell mentioned above and not described herein separately.

Various embodiments of the present disclosure having been thus described in detail by way of example, it will be apparent to those skilled in the art that variations and modifications may be made. The disclosure includes all such variations and modifications as fall within the scope of the appended claims.

1. An electrode assembly unit comprises an integration of a first electrode plate, a first separator plate, a second electrode plate, a second separator plate and another first electrode plate wherein the polarity of the first and second electrode plate are opposite to each other and the edges of the first and second separator plates join on one side forming a U-shape structure.

2. As claimed in 1, such electrode assembly unit further comprises the plates of the first separator and second separator having an adhesive layer on both sides for attachment of the electrode plates.

3. As claimed in 2, such electrode assembly unit further comprising a layer of ceramic particles between the surfaces of separator plate and adhesive layer for increased safety of the separator.

4. An electrode assembly unit comprising a top-to-bottom assembly of top separator plate, electrode plate and bottom separator plate.

5. As claimed in 4, the electrode assembly unit wherein the top and bottom separator plates are joined on one side forming U shape structure.

6. A manufacturing method for the electrode assembly unit comprising combining a first electrode plate, a first separator plate, a second electrode plate, a second separator plate and another first electrode plate,
wherein the polarity of the first and second electrode plate are opposite to each other, and
wherein the edges of the first and second separator plates join on one side forming U shape structure and wherein the electrode assembly unit includes a top separator plate, electrode plate and bottom separator plate as a single unit.

7. As claimed in 6, the manufacturing method of the electrode assembly comprises attaching the separator plate and adjacent electrode plate by adhesion or electrostatic attraction.

8. A battery cell made of one electrode assembly or two or more electrode assembly in a stacked arrangement where in the electrode assemblies are manufactured as claimed in 6.

9. The battery cell of claim 8, wherein where there are more than two electrode assembly units stacked forming the main stacking block and as the outermost layer of the main stacking block, the top side of the positive electrode is attached with negative electrode acting as auxiliary with a separator plate in between.
